(19) United States
(12) Patent Application Publication
(10) Pub. No.: US 2007/0204142 A1
(43) Pub. Date: Aug. 30, 2007

(54) Method and apparatus for repairing a link stack

(76) Inventors: James Norris Dieffenderfer, Apex, NC (US); David John Mandzak, Cary, NC (US); Rodney Wayne Smith, Raleigh, NC (US); Brian Michael Stempel, Raleigh, NC (US)

Correspondence Address: QUALCOMM INCORPORATED, 5775 MOREHOUSE DR., SAN DIEGO, CA, 92121, US

(21) Appl. No.: 11/363,072

(22) Filed: Feb. 27, 2006

(51) Int. Cl. G06F 15/00

(52) U.S. Cl. 712/242

(57) ABSTRACT

A link stack in a processor is repaired in response to a procedure return address misprediction error. In one example, a link stack for use in a processor is repaired by detecting an error in a procedure return address value retrieved from the link stack and skipping a procedure return address value currently queued for retrieval from the link stack responsive to detecting the error. In one or more embodiments, a link stack circuit comprises a link stack and a link stack pointer. The link stack is configured to store a plurality of procedure return address values. The link stack pointer is configured to skip a procedure return address value currently queued for retrieval from the link stack responsive to an error detected in a procedure return address value previously retrieved from the link stack.

### FIELD

The present disclosure generally relates to processors, and particularly relates to repairing link stack return errors in a processor.

### BACKGROUND

Conventional processors leverage instruction prefetching and speculative instruction execution to improve performance. Speculative instruction fetching is enabled by branch prediction mechanisms that utilize techniques for predicting the direction and target address of branch instructions early in an instruction pipeline. By predicting the outcome of branch instructions, processor resources can speculatively fetch instructions instead of idling (or simply fetching down a predetermined path) until the branch decisions are resolved further down the instruction pipeline. As such, processor performance can be improved if branches are predicted correctly.

For branch instructions relating to procedure calls and returns, conventional processors maintain a link stack for storing predicted return address values. Stored return address values correspond to the memory location of the next instruction to be fetched after a called procedure relinquishes program control. As such, a conventional processor stores or “pushes” a return address value onto a link stack when the processor predicts a branch instruction will result in a procedure call so that the processor can begin fetching a predicted return instruction stream when the called procedure returns. When a processor detects a return from a procedure call and predicts that the return will be taken, the processor retrieves or “pops” the return address value currently queued for retrieval from the link stack. The instruction associated with the popped return address value is then fetched from memory by the processor. Hence, a link stack provides a mechanism by which instructions predicted to follow procedure returns can be speculatively fetched by a processor before the procedure return itself has been executed by using the return address values stored in a link stack.

However, branches are not always predicted correctly. When a branch misprediction occurs, the processor may incur a significant performance penalty. Commonly, branch instructions resolve whether a predicted branch matches the actual branch decision near the end of the instruction pipeline. If a branch is predicted correctly, instruction fetching continues down the predicted path. However, if a branch is mispredicted, speculatively fetched instructions and their results are flushed from the processor pipeline and instruction fetching is redirected using the correct address.

Procedure return instructions may be mispredicted in a number of ways. For example, a link stack overflow causes return address values to be pushed off the stack. As such, one or more valid return address values may be missing from the stack, and thus cause a misprediction when the associated procedure return attempts to pop its value from the link stack. Also, conditional procedure returns may mispredict their branch direction. Further, procedure returns may be purposely skipped by software. That is, a procedure may call another procedure, i.e., nested procedure calls. A particular nested procedure may have no further instructions to execute when control is returned to it, other than to link back to the procedure that called it. As such, software may skip such procedure returns and link directly back to only those procedures that have substantive instructions to execute upon being returned to, thus improving performance of the code. When such optimized code is executed by a processor, one or more nested procedures may be skipped. However, conventional hardware link stacks do not skip return address values stored in the link stack. As such, a predicted return address value will be mispredicted using a conventional hardware link stack when a procedure return pops the link stack following a skipped procedure return instruction without an intervening branch and link instruction. The value popped was associated with the skipped return, not the subsequent return.

Conventional techniques for correcting mispredicted procedure returns consume several processor cycles. For example, when a return address value popped from a hardware link stack does not match the resolved address, a correction sequence is performed by the processor. Misprediction correction conventionally involves flushing the speculatively fetched instructions from the pipeline and fetching the correct instruction stream. However, the hardware link stack is not corrected for skipped returns. As such, the next hardware link stack entry popped is always at least one position (number of skipped returns) away from the correct entry. As a result, subsequent procedure returns associated with the link stack entries established before the skipped return will result in further mispredictions. Thus, a conventional processor must perform a correction sequence for each of these mispredictions. Performing a branch correction sequence each time an incorrect return address is popped from the hardware link stack reduces processor performance and increases power consumption, e.g., by consuming ten or more processor cycles to fetch instructions at the corrected address each time a return address misprediction error is detected.

### SUMMARY OF THE DISCLOSURE

According to the methods and apparatus taught herein, a link stack in a processor is repaired in response to a procedure return address misprediction error. In one or more embodiments, a link stack circuit comprises a link stack and a link stack pointer. The link stack is configured to store a plurality of procedure return address values. The link stack pointer is configured to skip a procedure return address value currently queued for retrieval from the link stack responsive to an error detected in a procedure return address value previously retrieved from the link stack.

Thus, in at least one embodiment, a link stack for use in a processor is repaired by detecting an error in a procedure return address value retrieved from the link stack and skipping a procedure return address value currently queued for retrieval from the link stack responsive to detecting the error. In one example, skipping the procedure return address value currently queued for retrieval comprises modifying a link stack pointer to skip the procedure return address value currently queued for retrieval responsive to detecting the error. The link stack pointer may be modified by saving a link stack pointer index corresponding to the procedure return address value that caused the error and replacing a current link stack pointer index with the saved link stack pointer index offset by two link stack entry locations. In another example, skipping the procedure return address value currently queued for retrieval comprises popping from the link stack a procedure return address value queued immediately after the procedure return address value that caused the error and popping from the link stack a procedure return address value queued immediately after the popped procedure return address value.

Corresponding to the above apparatuses and methods, a complementary processor comprises a link stack and instruction fetch logic. The link stack is configured to store a plurality of procedure return address values. The instruction fetch logic is configured to skip a procedure return address value currently queued for retrieval from the link stack responsive to an error detected in a procedure return address value previously retrieved from the link stack. In one embodiment, the link stack comprises a circular buffer. The instruction fetch logic is configured to skip the procedure return address value currently queued for retrieval from the circular buffer by modifying a link stack pointer to skip the procedure return address value queued for retrieval. In another embodiment, the link stack comprises a push-pop buffer. The instruction fetch logic is configured to skip the procedure return address value currently queued for retrieval by popping from the push-pop buffer a procedure return address value queued immediately after the procedure return address value that caused the error and popping from the push-pop buffer a procedure return address value queued immediately after the popped procedure return address value.

Of course, the present disclosure is not limited to the above features. Those skilled in the art will recognize additional features upon reading the following detailed description, and upon viewing the accompanying drawings.

### BRIEF DESCRIPTION OF DRAWINGS

FIG. 1 is a block diagram illustrating an embodiment of a processor including a repairable link stack.

FIG. 2 is a logic flow diagram illustrating an embodiment of program logic for repairing a link stack included in a processor.

FIG. 3 is a logic flow diagram illustrating another embodiment of program logic for repairing a link stack included in a processor.

FIG. 4 is a logic flow diagram illustrating yet another embodiment of program logic for repairing a link stack included in a processor.

FIG. 5 is a program instruction flow diagram illustrating a series of nested procedure returns that are linked using a repairable link stack.

FIG. 6 is a program instruction flow diagram illustrating de-linking of the nested procedure returns illustrated in FIG. 5 using a repairable link stack.

### DETAILED DESCRIPTION

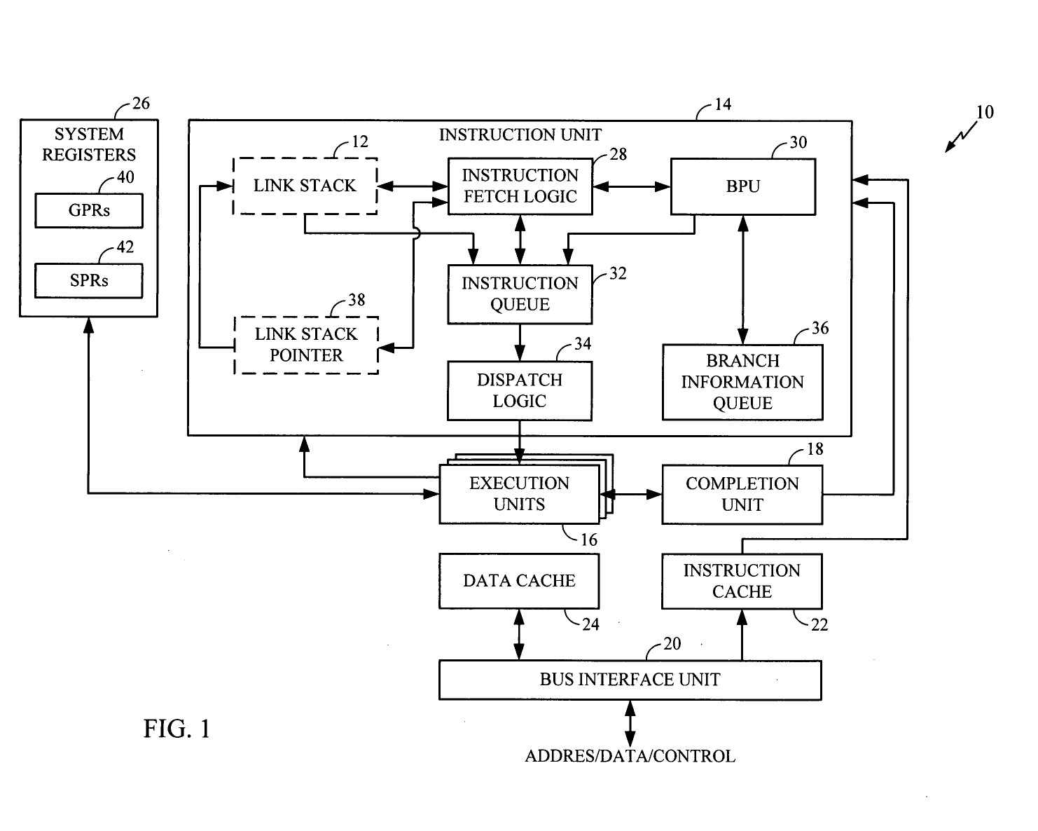

FIG. 1 illustrates an embodiment of a processor 10 including a link stack 12 for storing predicted return address values, i.e., an address value that points to or otherwise indicates a memory location at which an instruction predicted or expected to follow a procedure return is stored. The processor 10 serves as a central or main processing unit in a computing system (not shown), e.g., a server, desktop computer, or mobile device such as a portable computer, mobile phone, personal digital assistant or the like. The processor 10 executes a collection of instructions that cause the processor 10 to take certain actions, possibly including branch prediction and speculative instruction fetching. The link stack 12 can in many cases be repaired in response to a return address misprediction error by skipping the return address value currently queued for retrieval from the link stack 12, as will be described in detail below.

The processor 10 further comprises an instruction unit 14, a plurality of execution units 16, a completion unit 18, a bus interface unit 20, instruction and data caches 22, 24 and a plurality of system registers 26, including general purpose registers (40) and stack pointer registers (42). The instruction unit 14 provides centralized control of instruction flow to the execution units 16. The execution units 16, which may include one or more load/store units (not shown), floating point units (not shown), and integer units (not shown) may execute multiple instructions in parallel. As such, the processor 10 may be superscalar and/or superpipelined. Further, one or more of the execution units 16 may resolve predicted branches. The completion unit 18 tracks instructions from dispatch through execution. The bus interface unit 20 provides a mechanism for transferring data, addresses and control signals to and from the processor 10. The instruction and data caches 22, 24 enable the system registers 26 and the execution units 16 to rapidly access instructions and data. Further, data may be moved between the data cache 24 and the system registers 26 via one of the execution units 16, e.g. a load/store unit (not shown).

In more detail, the instruction unit 14 includes instruction fetch logic 28, a Branch Prediction Unit (BPU) 30, an instruction queue 32, instruction dispatch logic 34, and a branch information queue 36. The link stack 12 and link stack pointer 38 are included in or associated with the instruction unit 14. The instruction fetch logic 28 retrieves instructions from the instruction cache 22, decodes them and loads the decoded instructions into the instruction queue 32. The instruction dispatch logic 34 dispatches queued instructions to the appropriate execution units 16. Depending upon the type of branch detected, the BPU 30 executes various branch prediction mechanisms, e.g., predicting branch target addresses and/or whether a particular branch is to be taken. Further, the BPU 30 maintains the branch information queue 36 which contains information relating to branch instructions placed there by the BPU 30. For example, the branch information queue 36 may contain an indication as to whether a particular branch is unconditionally taken, the predicted target address, the predicted branch direction, etc. The branch information queue 36 may be used by the processor 10 to determine whether a branch is predicted correctly, and if not, where to start instruction fetching and how to update branch history tables (not shown). For example, the processor 10 compares actual results determined by one or more of the execution units 16 with predicted results stored in the branch information queue 36 to determine whether a branch was predicted correctly.

When the instruction fetch logic 28 retrieves a branch instruction relating to a procedure call, herein referred to as a “branch and link instruction”, the instruction fetch logic 28 pushes the address of the sequential instruction following the branch and link instruction onto the link stack 12. The next sequential instruction address is normally used as the return address for a procedure return instruction. Each time a branch and link instruction is detected and predicted taken by the instruction fetch logic 28, a corresponding return address value is pushed onto the link stack 12. As such, the link stack 12 contains a chain of predicted return addresses associated with a series of chained or linked procedures. If the link stack 12 is implemented as a circular buffer, the instruction fetch logic 28 also updates a link stack pointer 38 with an index value that points to an entry in the link stack 12 corresponding to the return address value that was most recently pushed onto the link stack 12. As such, the link stack pointer 38 points to the link stack entry currently queued for retrieval. In one example, the link stack pointer 38 is updated by incrementing its pointer index by the equivalent of one link stack entry position in response to a new address value being pushed onto the link stack 12.

When the instruction fetch logic 28 retrieves a branch instruction relating to a procedure return, herein referred to as a “branch to link instruction”, the instruction fetch logic 28 pops the return address value currently queued for retrieval from the link stack 12. Particularly, the return address value presently indicated by the link stack pointer 38 is popped from the link stack 12 and the instruction located at the predicted return address is fetched from the memory location indicated by the popped address value. For example, the instruction located at the predicted return address is fetched from a location in the instruction cache 22 or in external memory which corresponds to the popped return address value. After an address value is popped from the link stack 12, the pointer index in the link stack pointer 38 is decremented to point to the next return address value queued in the link stack 12.

The link stack pointer 38 may be included in or associated with the instruction unit 14. The current pointer index contained in the link stack pointer 38 is stored in conjunction with popping the corresponding return address value from the link stack 12, e.g., in the branch information queue 36 by the BPU 30. Stored pointer indexes are subsequently used to repair the link stack 12 after a return address misprediction error occurs, as will be described in detail below. In one example, the stored pointer index travels with the branch instruction through the pipeline. In another example, the current pointer index is associated with its corresponding predicted branch instruction by storing the pointer index in the branch information queue 36 along with instruction information, e.g., the predicted branch instruction or pertinent information relating to the instruction.

In another embodiment, the link stack 12 is implemented as a true push-pop buffer (not shown) where saved return address values are each shifted down one spot when a new address value is pushed onto the link stack 12 and shifted up one spot when an address value is popped from the link stack 12. As such, no link stack pointer 38 is required. Instead, return address values are simply pushed onto the link stack 12 responsive to branch and link instructions and popped from the link stack 12 responsive to branch to link instructions.

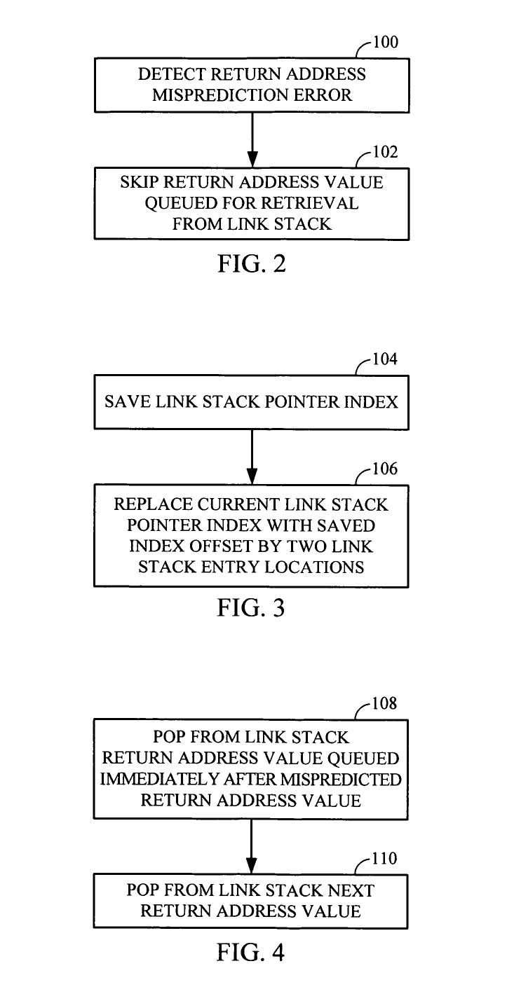

When the processor 10 detects a return address misprediction error, as illustrated by Step 100 of FIG. 2, the processor 10 performs a correction sequence. The processor 10 may detect return address misprediction errors such as link stack overflows and procedure returns skipped by software code. Misprediction correction conventionally involves flushing the speculatively fetched instructions from the pipeline and fetching the correct instruction stream. In response to the processor 10 detecting a return address misprediction error, the instruction fetch logic 28 repairs the link stack 12 by causing the link stack 12 to skip the return address value currently queued for retrieval, as illustrated by Step 102 of FIG. 2. In the case where software has skipped a procedure return, if the return address value currently queued for retrieval from the link stack 12 is not skipped, then a return address misprediction error will automatically occur the next time an address is popped from the link stack 12 if no intervening branch and link instructions have caused a value to be pushed onto the link stack. An error occurs because the address value currently queued for retrieval from the link stack 12 corresponds to a procedure return instruction that has been skipped. As such, skipping the return address value currently queued for retrieval from the hardware link stack 12 reduces the likelihood that an address misprediction will occur during the next link stack pop by re-synchronizing the link stack with the software's chain of procedure calls and returns.

FIG. 3 illustrates one embodiment of program logic for causing the link stack 12 to skip a return address value currently queued for retrieval where the link stack 12 comprises a circular buffer. Each time a return address value is popped from the link stack 12, the link stack pointer index 38 associated with the popped address value is saved as previously described (Step 104). Thus, link stack pointer indexes associated with popped return address values are available to repair the link stack if required. In response to the processor 10 detecting a return address misprediction error, the saved pointer index associated with the mispredicted return address is used by the instruction fetch logic 28 to repair the link stack 12 by causing the link stack 12 to skip the return address value currently queued for retrieval. Particularly, the instruction fetch logic 28 replaces the current pointer index contained in the link stack pointer 38 with the saved pointer index offset by two link stack entry locations (Step 106). In one example, the instruction fetch logic 28 includes or has access to a logic circuit such as an adder circuit (not shown) or an arithmetic logic unit (not shown) capable of decrementing the saved link stack pointer index by two link stack entry locations. As a result, the return address value stored two entry locations away from the address value that caused the misprediction error is now currently queued for retrieval from the link stack 12, thereby reducing the likelihood of a subsequent procedure return address misprediction error.

FIG. 4 illustrates another embodiment of program logic for causing the link stack 12 to skip a return address value currently queued for retrieval where the link stack 12 comprises a push-pop buffer. In response to the processor 10 detecting a mispredicted return address value, the instruction fetch logic 28 repairs the link stack 12 by causing the link stack 12 to pop the currently queued link stack entry, i.e., the entry queued immediately after the return address value that caused the error (Step 108). The instruction fetch logic 28 then causes the link stack 12 to pop the immediately succeeding return address value. As such, the link stack 12 performs two successive pops, thus skipping the return address value that was queued for retrieval immediately following the mispredicted address value. Regardless of the particular link stack implementation, at least one iteration of the branch correction sequence is avoided by causing the link stack to skip a return address value queued for retrieval immediately after a mispredicted address value.

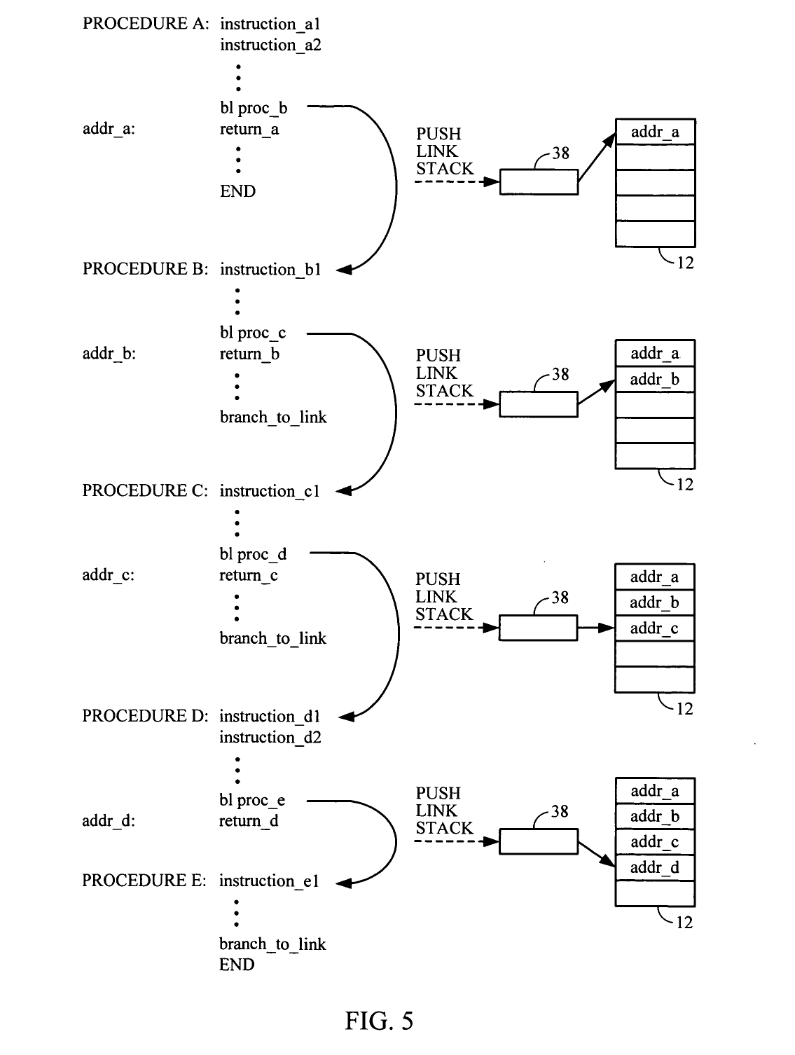

FIG. 5 illustrates a series of exemplary program instructions that cause several chained or linked return address values to be pushed onto the link stack 12 and the link stack pointer 38 to be updated accordingly. According to the illustrated program flow, procedure A calls procedure B using a branch and link instruction (bl proc_b). Likewise, procedure B calls procedure C (bl proc_c), procedure C calls procedure D (bl proc_d) and procedure D calls procedure E (bl proc_e). In total, there are four procedure calls that are nested and chained to procedure A. As such, each time a branch and link instruction that is predicted or known to be taken is detected, a corresponding return address value is pushed onto the link stack 12 to enable return address prediction, e.g., addr_a, addr_b, etc. Each return address pushed onto the link stack 12 identifies a memory address which corresponds to the memory location of the next instruction to be fetched after a called procedure relinquishes program control, e.g., return_a, return_b, etc. The link stack pointer 38 is updated in response to each predicted or known taken branch and link instruction so that the most recently pushed stack entry is indicated by the link stack pointer 38. As such, a series of addresses associated with a chain of procedure return instructions are established in the link stack 12 in program order using the link stack pointer 38.

In this particular example, after procedure D calls procedure E, procedure D no longer includes any instructions for execution except for a branch to link instruction, where returned represents the branch to link instruction. That branch to link instruction simply restores program control to procedure C. As such, optimized software code in procedure E may skip this branch to link instruction (returned) and return program control directly to procedure C (return_c). Thus, when the branch to link instruction associated with procedure E is resolved, program control will be returned directly to procedure C and not procedure D, causing the procedure return instruction associated with procedure D to be skipped by optimized code in procedure E. However, the link stack 12 is unaware that a procedure return has been skipped. As a result, the link stack 12 delivers the address associated with the skipped return (addr_d) instead of the address associated with the next return (addr_c), where the software has redirected the program flow. Thus, a return address misprediction error will occur when the link stack pointer 38 causes the return address value associated with procedure D (addr_d) to be popped from the link stack 12 and speculatively fetched.

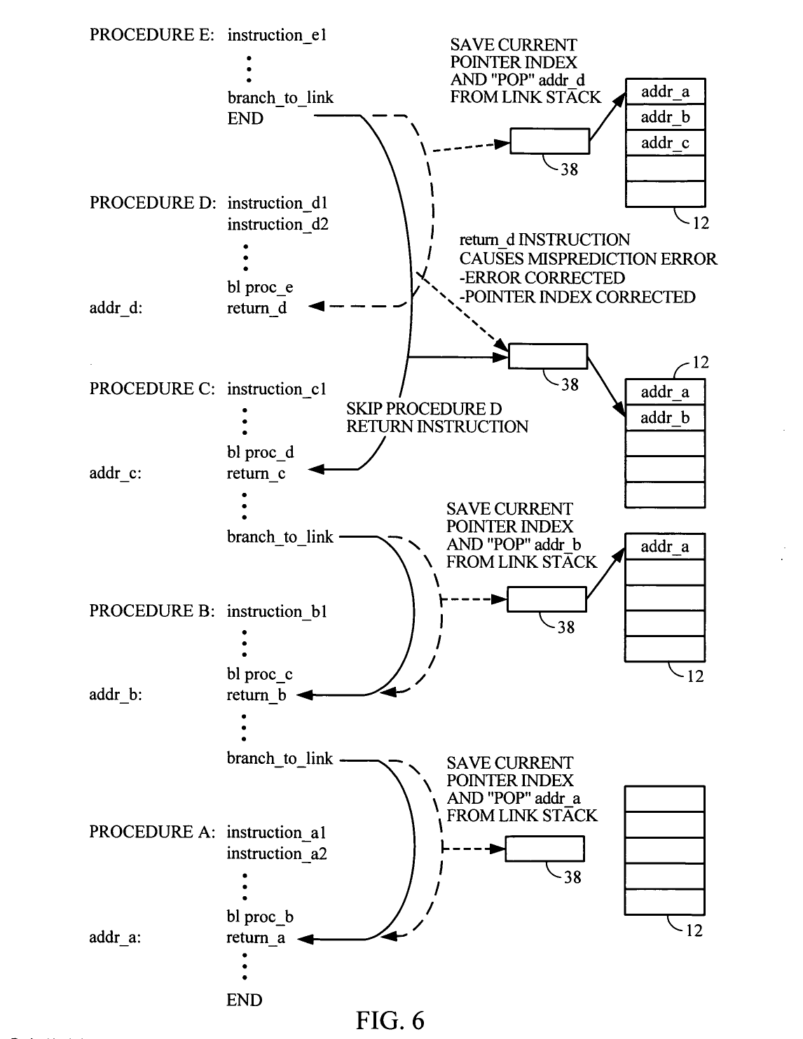

FIG. 6 illustrates a series of exemplary program instructions that cause the return address values previously pushed onto the link stack 12 in accordance with the exemplary program instructions illustrated in FIG. 5 to be popped from the link stack 12, thus causing a misprediction error. In FIG. 6, the actual program return path as determined by optimized code is represented by solid lines while the return path as predicted by the link stack pointer 38 in conjunction with the link stack 12 is represented by dashed lines. Upon encountering the branch to link instruction at the end of procedure E, the link stack pointer 38 points to the return address value associated with procedure D (addr_d). As such, addr_d is popped from the link stack 12 and the corresponding instruction (returned) is fetched. However, using the return address value associated with procedure D (addr_d) causes an address misprediction error because the actual address is the return address value associated with procedure C (addr_c) as dictated by the optimized code in procedure E.

In response to the address misprediction, a correction sequence is performed by the processor 10 as previously described. It is appropriate to note that a conventional link stack included in a conventional processor is not repaired in response to an address misprediction. As such, each time a return address value is popped from a conventional link stack after an initial address misprediction occurs, a correction sequence is performed. That is, a conventional link stack pointer will point to the wrong return address each time an entry is subsequently popped from the conventional link stack after an initial address misprediction occurs because the conventional link stack is not modified in response to address misprediction errors. As such, after an initial address misprediction, each return address value subsequently popped from a conventional link stack causes the conventional processor to execute a correction sequence because the conventional link stack pointer points to at least one link stack entry away from the correct entry.

Returning to FIG. 6, the instruction fetch logic 28 retrieves the saved link stack pointer index associated with the branch to link instruction that had the return address misprediction error. The instruction fetch logic 28 then repairs the link stack 12 by replacing the current link stack pointer index contained in the link stack pointer 38 with the saved link stack pointer index offset by two link stack entry locations. As such, when procedure C eventually returns control to procedure B, the link stack pointer 38 will not be pointing to the return address value associated with procedure C (addr_c), but instead will point to the return address value associated with procedure B (addr_b). Thus, in the example illustrated in FIG. 6, subsequent return address misprediction errors are prevented.

With the above range of variations and applications in mind, it should be understood that the present disclosure is not limited by the foregoing description, nor is it limited by the accompanying drawings. Instead, the present disclosure is limited only by the following claims and their legal equivalents.

1. A method of repairing a link stack for use in a processor, comprising:
detecting an error in a procedure return address value retrieved from the link stack; and
skipping a procedure return address value currently queued for retrieval from the link stack responsive to detecting the error.

2. The method of claim 1, wherein skipping the procedure return address value currently queued for retrieval comprises modifying a link stack pointer to skip the procedure return address value currently queued for retrieval responsive to detecting the error.

3. The method of claim 2, wherein modifying the link stack pointer to skip the procedure return address value currently queued for retrieval comprises:
saving a link stack pointer index corresponding to the procedure return address value that caused the error; and
replacing a current link stack pointer index with the saved link stack pointer index offset by two link stack entry locations responsive to detecting the error.

4. The method of claim 3, wherein saving the link stack pointer index comprises saving the link stack pointer index in conjunction with popping from the link stack the procedure return address value that caused the error.

5. The method of claim 3, further comprising associating the saved link stack pointer index with branch instruction information corresponding to the saved link stack pointer index.

6. The method of claim 1, wherein skipping the procedure return address value currently queued for retrieval comprises:
popping from the link stack a first procedure return address value queued immediately after the procedure return address value that caused the error; and
popping from the link stack a second procedure return address value queued immediately after the first popped procedure return address value.

7. The method of claim 1, wherein detecting an error in the procedure return address value retrieved from the link stack comprises detecting a link stack overflow or a skipped program return.

8. A processor, comprising:
a link stack configured to store a plurality of procedure return address values; and
instruction fetch logic configured to skip a procedure return address value currently queued for retrieval from the link stack responsive to an error detected in a procedure return address value previously retrieved from the link stack.

9. The processor of claim 8, wherein the link stack comprises a circular buffer.

10. The processor of claim 9, wherein the instruction fetch logic is configured to skip the procedure return address value currently queued for retrieval by modifying a link stack pointer to skip the procedure return address value currently queued for retrieval responsive to the detected error.

11. The processor of claim 10, wherein the instruction fetch logic is configured to modify the link stack pointer to skip the procedure return address value currently queued for retrieval by saving a link stack pointer index corresponding to the procedure return address value that caused the error and replacing a current link stack pointer index with the saved stack pointer index offset by two link stack entry locations responsive to detecting the error.

12. The processor of claim 11, further comprising a queue configured to store instruction information corresponding to the saved link stack pointer index and to associate the stored instruction information with the saved link stack pointer index.

13. The processor of claim 8, wherein the link stack comprises a push-pop buffer.

14. The processor of claim 13, wherein the instruction fetch logic is configured to skip the procedure return address value currently queued for retrieval by popping from the push-pop buffer a first procedure return address value queued immediately after the procedure return address value that caused the error and popping from the push-pop buffer a second procedure return address value queued immediately after the first popped procedure return address value.

15. The processor of claim 8, wherein the detected error comprises a link stack overflow or a skipped program return.

16. A link stack circuit for use in a processor, comprising:
a link stack configured to store a plurality of procedure return address values; and
a link stack pointer configured to skip a procedure return address value currently queued for retrieval from the link stack responsive to an error detected in a procedure return address value previously retrieved from the link stack.

17. The link stack circuit of claim 16, wherein the link stack comprises a circular buffer.

18. The link stack circuit of claim 16, wherein the link stack pointer is configured to skip the procedure return address value currently queued for retrieval by pointing to an entry in the link stack that corresponds to a procedure return address value stored immediately after the procedure return address value currently queued for retrieval responsive to the detected error.

19. The link stack circuit of claim 18, wherein the link stack pointer is configured to point to the entry in the link stack that corresponds to the procedure return address value stored immediately after the procedure return address value currently queued for retrieval by replacing a current link stack pointer index with a saved link stack pointer index offset by two link stack entry locations responsive to the detected error.

20. The link stack circuit of claim 16, wherein the detected error comprises a link stack overflow or a skipped program return.
